(19) United States
(12) Patent Application Publication
(10) Pub. No.: US 2024/0243771 A1
(43) Pub. Date: Jul. 18, 2024

(54) Lens protector for a handheld smart device and method of use

(71) Applicant: Nevada Breeze, Pasadena, CA (US)

(72) Inventor: Nevada Breeze, Pasadena, CA (US)

(21) Appl. No.: 17/498,227

(22) Filed: Oct. 11, 2021

Related U.S. Application Data
(60) Provisional application No. 63/191,178, filed on May 20, 2021.
(60) Provisional application No. 63/186,570, filed on May 10, 2021.

(51) Int. Cl. H04B 1/3888; F16M 13/04; H04M 1/04

(52) U.S. Cl. CPC H04B 1/3888; F16M 13/04; H04M 1/04

(57) ABSTRACT

A lens protector for a handheld smart device, the handheld smart device having a top section, a bottom edge, at least one camera lens disposed at said top section, includes a hood fabricated from a flexible material. The hood is configured to wrap around the top section of the handheld smart device and cover the camera lens or lenses. The hood is held in place by four elastic bands which wrap around the bottom edge of the handheld smart device. In an embodiment, the hood is rectangular and has four corners, with four elastic bands connected to the four corners. The elastic bands can be fabricated from a friction-enhancing material to better grip the surface of the smart device.

### CROSS REFERENCE TO RELATED APPLICATION

This application claims the filing benefit under 35 U.S.C. § 119(e) of U.S. Provisional Application No. 63/191,178 filed May 20, 1921, which is hereby incorporated by reference. This application also claims the filing benefit under 35 U.S.C. § 119(e) of U.S. Provisional Application No. 63/186,570 filed May 10, 1921, which is hereby incorporated by reference.

### TECHNICAL FIELD

The present invention pertains generally to handheld smart devices having cameras, and more particularly to a lens protector which covers the lens of the camera when the camera is not being used.

### BACKGROUND OF THE INVENTION

Handheld smart devices such as smartphones, tablet computers, and the like have one or more cameras. The camera lenses can be disposed on both the back (forward facing) and the front (back facing side) of the handheld smart device. Because the lenses are located on a handheld device, fingerprints can degrade the performance of the cameras. Also, foreign matter such as food or other contaminants can accumulate over the lenses. In other cases the lenses can be cracked, scratched, or otherwise damaged by contact with various objects.

Camera pictures and/or videos can be inadvertently initiated by the user, or even initiated by a hacker who has obtained access to the handheld smart device. All of the above point to the need for a effective lens protector for the handheld smart device which covers and/or protect camera lenses when not in use.

Smartphones and other handheld smart devices are provided to serve a variety of different functions. Application software (called “apps”) operates on the smart device, within a processor and memory of the handheld smart device, and interacting with various different inputs and outputs. One common feature of many such smart devices is the provision of at least one camera, and typically multiple cameras including at least a forward facing camera and a rearward facing camera. The cameras facilitate operation of at least some of the apps on the handheld smart device. For instance, a camera app can utilize one or more of the cameras of the handheld smart device to take photos and videos. Video communications apps can also utilize one or more of the cameras to assist in providing a video telecommunications session between a user of the handheld smart device and some other smart device or terminal.

Many handheld smart devices have a relatively common shape being generally orthorhombic with a height greater than a width and a width greater than a thickness. Typically, the thickness is less than about half an inch. The width of the handheld smart device is typically less than about 3 inches. The height of the handheld smart device is typically less than about 7 inches. When the handheld smart device is in the form of a tablet, these dimensions are significantly larger. Forward and reverse facing cameras are typically located along a common edge, typically an edge which is considered to be an upper edge of the handheld smart device.

While handheld smart devices are configured to be easily used in a manner consistent with the desires of a user, on occasion a handheld smart device will unintentionally operate in an undesired manner. For instance, it is known for a handheld smart device to dial a phone number and call someone merely by placing the handheld smart device in a pocket without turning off the smart device. On occasion, a telephone call will be initiated and the user does not even know that this telephone call has been initiated. A person on the other end of the telephone call then has an inadvertent opportunity to listen in on any sounds present adjacent to the user. Such unintentional operation can lead to loss of valuable secrets and loss of privacy generally, as well as causing a variety of other undesirable ramifications. Similarly, it is possible to initiate a video telecommunication session or to inadvertently record video or take still pictures by inadvertently pushing buttons while the camera app or some other app utilizing the camera of the handheld smart device is in operation. Thus a similar or even more severe loss of privacy can result.

### BRIEF SUMMARY OF THE INVENTION

The present invention is directed to a lens protector for a handheld smart device such as a smart phone or tablet computer. The lens protector includes a hood with connected elastic bands. The lens protector is temporarily installed on the handheld smart device so that the hood covers the lens or lenses of the handheld smart device's cameras. The elastic bands are wrapped around the bottom edge of the handheld smart device and hold the hood in place. The lens protector, and in particular the hood, protect the lens or lenses of the handheld smart device from mechanical damage or contamination, and further prevent unauthorized use of the handheld smart device's cameras.

In accordance with an embodiment, a lens protector for a handheld smart device is disclosed. The handheld smart device has a top section, a bottom edge, and a camera lens is disposed at the top section. The lens protector includes a hood which is fabricated from a flexible material. The hood is configured to wrap around the top section of the handheld smart device and cover the camera lens. Four elastic bands are connectable to the hood, the four elastic bands being configured to wrap around the bottom edge of the handheld smart device.

In accordance with another embodiment, the hood is rectangular and has four corners. One elastic band is connectable to each of the four corners.

In accordance with another embodiment, the hood has four apertures, one aperture disposed at each of the four corners.

In accordance with another embodiment, the four apertures are formed by four grommets.

In accordance with another embodiment, the four elastic bands are removably connectable to the hood.

In accordance with another embodiment, the elastic bands are configured to pass through the apertures and loop back though themselves.

In accordance with another embodiment, the hood is fabricated from a friction-enhancing material.

In accordance with another embodiment, the elastic bands are fabricated from a friction-enhancing material.

In accordance with another embodiment, the elastic bands have a thickness of less than one sixteenth of an inch.

In accordance with another embodiment, the handheld smart device has a left edge and a right edge. Two of the elastic bands are disposable adjacent to the left edge of the handheld smart device, and two of the elastic bands disposable adjacent to the right edge of the handheld smart device.

In accordance with another embodiment, a lens protector is provided for at least one camera of a handheld smart device. The lens protector comprises in combination a hood of flexible material which has four corners. Four elastic bands are coupled to the hood of flexible material, the elastic bands are located adjacent to the four corners of the hood of flexible material.

In accordance with another embodiment, the hood of flexible material and the elastic bands are formed from a common sheet of flexible elastic material.

In accordance with another embodiment, the elastic bands and the hood of flexible material are formed of separate structures, and with the hood of flexible material including at least four apertures adjacent to the four corners of the hood of flexible material, and with one of the elastic bands interfacing with each of the apertures.

In accordance with another embodiment, the elastic bands are tied in position passing through the apertures.

In accordance with another embodiment, the apertures are formed by four grommets.

In accordance with another embodiment, the hood of flexible material has a rectangular form.

In accordance with another embodiment, the hood of flexible material is between 2.5 and 3.5 inches wide, and between 4 and 4.5 inches long.

In accordance with another embodiment, the hood of flexible material is between 3.5 and 4.5 inches wide, and between 4.5 and 5.5 inches long.

In accordance with another embodiment, 18, the hood of flexible material is between 4.5 and 5.5 inches wide, and between 5.5 and 6.5 inches long.

In accordance with another embodiment, the hood of flexible material is formed of leather.

In accordance with another embodiment, the hood of flexible material is formed of fabric.

In accordance with another embodiment, the hood of flexible material is formed of a planar sheet of rubber.

Other embodiments, in addition to the embodiments enumerated above, will become apparent from the following detailed description, taken in conjunction with the accompanying drawings, which illustrate, by way of example, the principles of the lens protector for a handheld smart device and method of use.

### BRIEF DESCRIPTION OF THE DRAWINGS

FIG. 1 is a top plan view of a prior art handheld smart device;

FIG. 2 is a front elevation view of the prior art handheld smart device;

FIG. 3 is a bottom plan view of the prior art handheld smart device;

FIG. 4 is a side elevation view of the prior art handheld smart device;

FIG. 5 is an opposite side elevation view of the prior art smart device;

FIG. 6 is a rear elevation view of the prior art handheld smart device;

FIG. 7 is a top perspective view of the handheld smart device;

FIG. 8 is a front plan view of a lens protector for a handheld smart device in accordance with the present invention;

FIG. 9 is a side elevation view of the lens protector;

FIG. 10 is another side elevation view of the lens protector;

FIG. 11 is a rear plan view of the lens protector;

FIG. 12 is perspective view of the lens protector;

FIG. 13 is a top view of the handheld smart device with the lens protector installed thereon;

FIG. 14 is a front view of the handheld smart device with the lens protector;

FIG. 15 is a bottom view of the handheld smart device with the lens protector;

FIG. 16 is a side elevation view of the handheld smart device with the lens protector;

FIG. 17 is an opposite side elevation view of the handheld smart device with the lens protector;

FIG. 18 is a rear view of the handheld smart device with the lens protector;

FIG. 19 is a perspective view of the lens protector with elastic bands disconnected from a hood;

FIG. 20 is a cross sectional view along the line 20-20 of FIG. 19;

FIG. 21 is a plan view of another embodiment elastic band;

FIG. 22 is a cross sectional view along the line 22-22 of FIG. 21;

FIG. 23 is a plan view of a second embodiment lens protector;

FIG. 24 is a front view of the lens protector installed on a tablet computer;

FIG. 25 is a front plan view of the lens protector;

FIG. 26 is a side elevation view of the lens protector;

FIG. 27 is another side elevation view of the lens protector;

FIG. 28 is a rear plan view of the lens protector;

FIG. 29 is another front view of the handheld smart device with the lens protector.

FIG. 30 is another front plan view of the lens protector;

FIG. 31 is another side elevation view of the lens protector;

FIG. 32 is another side elevation view of the lens protector;

FIG. 33 is another rear plan view of the lens protector;

FIG. 34 is another perspective view of the lens protector;

FIG. 35 is another front plan view the a lens protector;

FIG. 36 is another side elevation view of the lens protector;

FIG. 37 is another side elevation view of the lens protector; and,

FIG. 38 is another rear plan view of the lens protector.

### DETAILED DESCRIPTION OF THE INVENTION

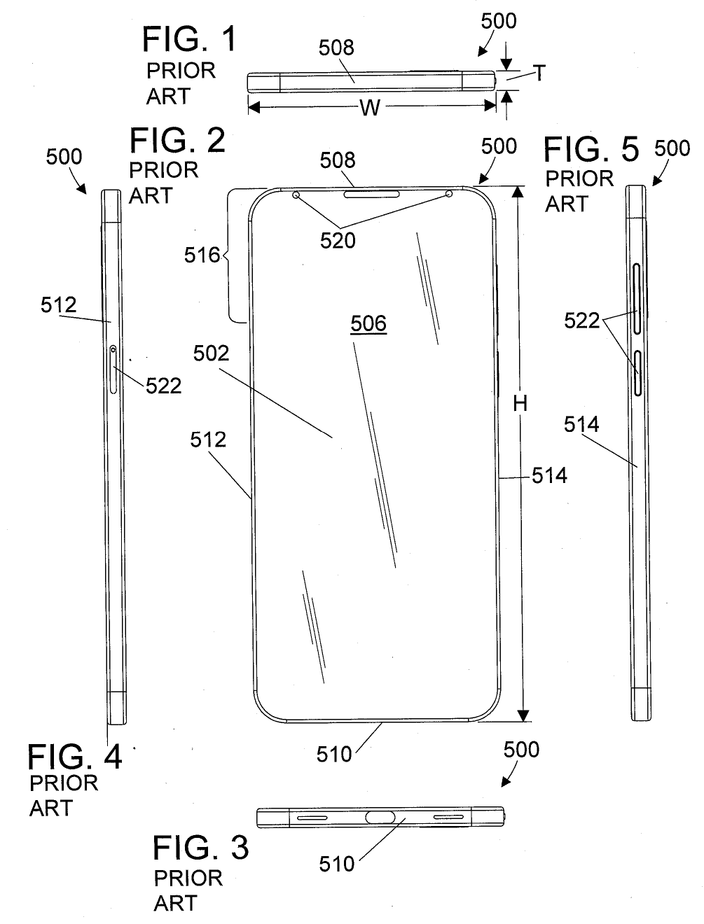

Referring initially to FIGS. 1-7, there are illustrated top plan, front elevation, bottom plan, side elevation, opposite side elevation, rear elevation, and perspective views respectively of a prior art handheld smart device, generally designated as 500. In the shown embodiment handheld smart device 500 is a smartphone, however other types of handheld smart devices 500 such as tablet computers, other phones with cameras, and the like can also fit the definition. Handheld smart device 500 has a front side 502 and an opposite rear side 504. A display 506 is disposed on front side 502. When in the upright position of FIG. 2, handheld smart device 500 includes a top edge 508, a bottom edge 510, a left edge 512, and a right edge 514.

Most handheld smart devices have a relatively common shape being generally orthorhombic with a height H greater than a width W, and the width W greater than a thickness T. While the dimensions vary as a function of manufacturer and model, typically the height H of a handheld smart device 500 is less than about six inches, the width W is less that about three inches, and the thickness T is less than one half inch. Tablet computers are larger.

Handheld smart device 500 further includes a top section 516 which includes top edge 508 and the area below top edge 508 where at least one camera lens 520 is disposed. In the shown embodiment there are four camera lenses 520, two disposed on front side 502 and two disposed on rear side 504. It may be appreciated however that handheld smart device 500 can include other numbers of lenses 520. The lowermost part (the part closest to bottom edge 510) of camera lens 520 is disposed a distance D from top edge 508. In the shown embodiment, the lowermost point is on rear side 504. Handheld smart device 500 further includes function controls 522 which in the shown embodiment are disposed along left edge 512 and right edge 514.

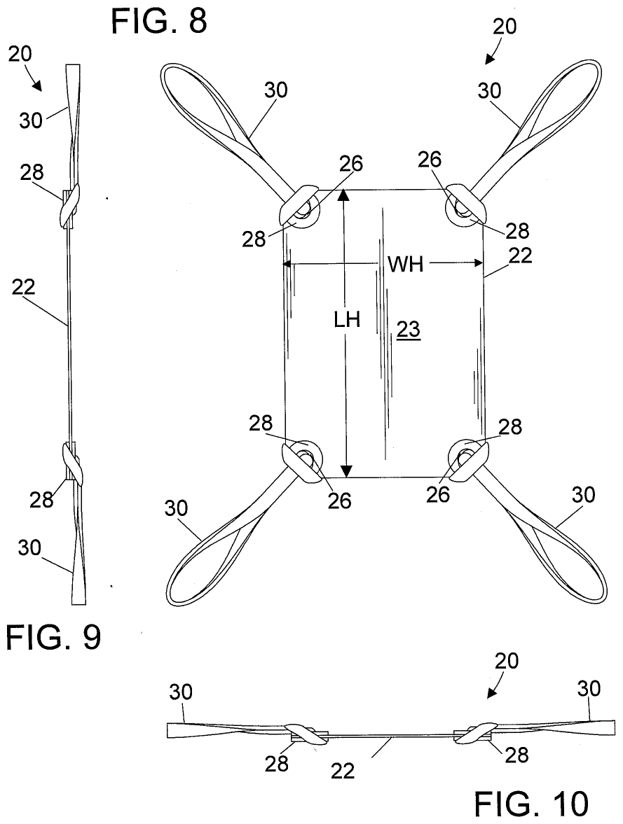

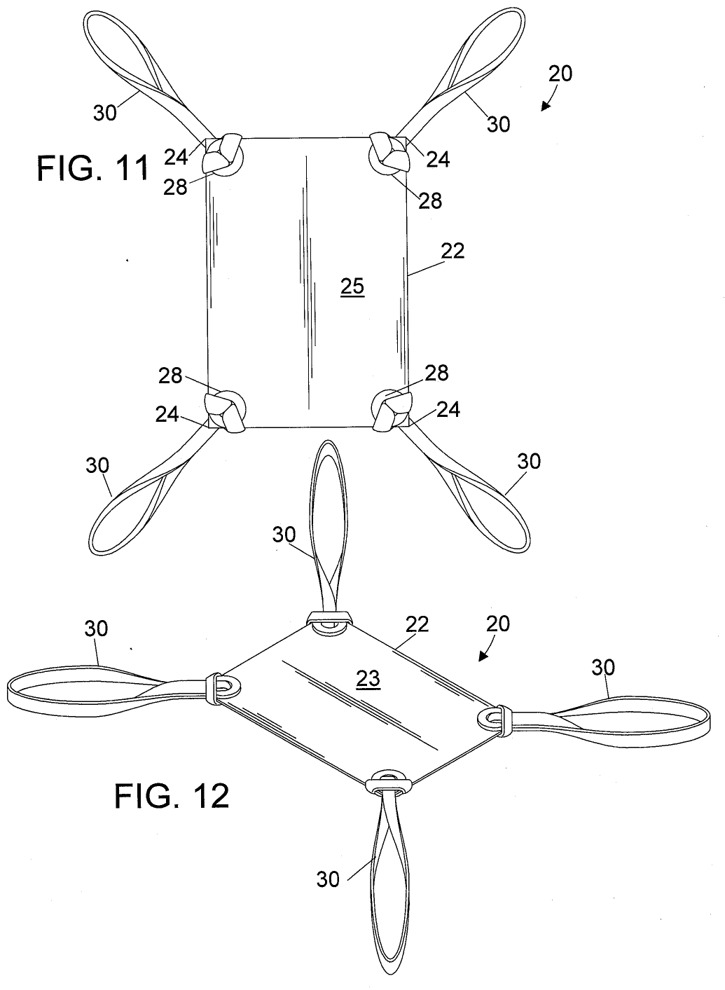

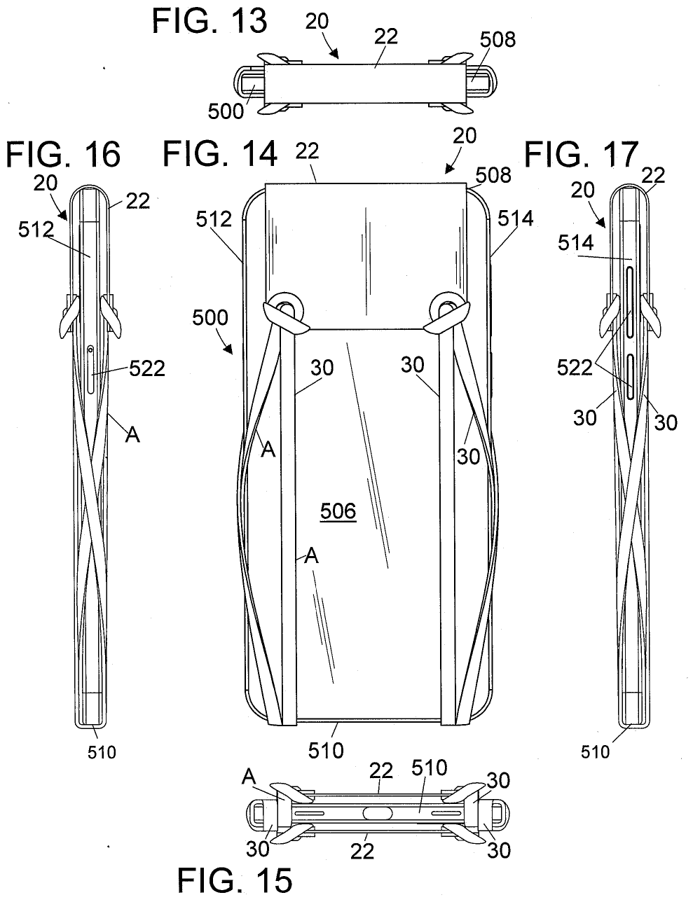

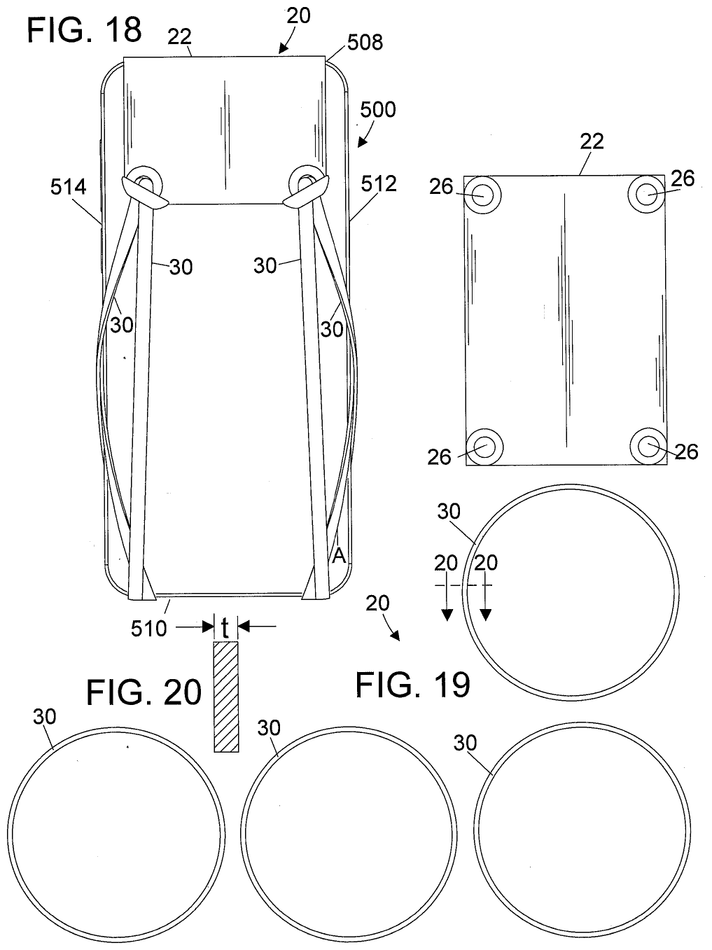

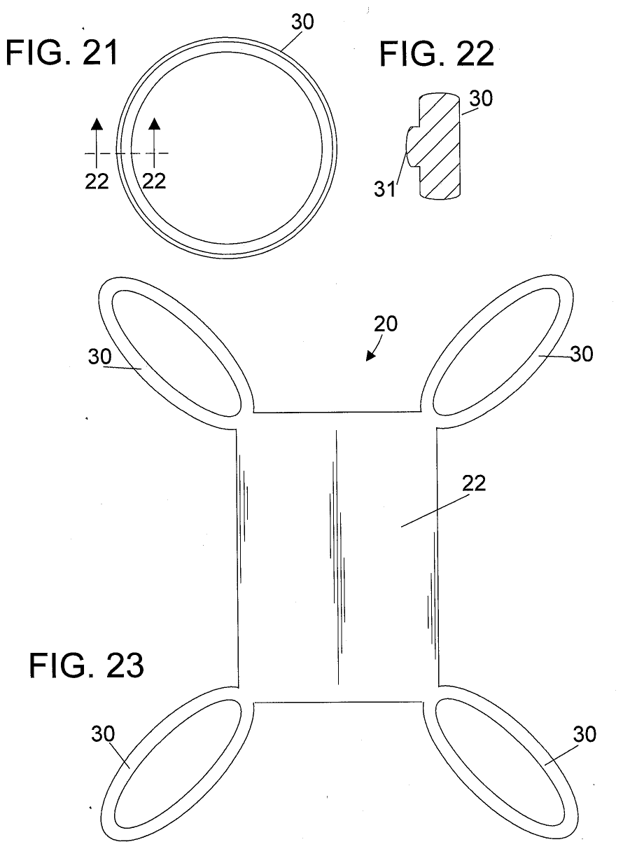

Referring now to FIGS. 8-12, there are illustrated front plan, side elevation, another side elevation, rear plan, and perspective views respectively of a lens protector for a smart device in accordance with the present invention, the lens protector generally designated as 20. Lens protector 20 includes a hood 22 which has a front surface 23 and an opposite rear surface 25. Hood 22 is configured to wrap around the top section 516 of handheld smart device 500, and cover camera lens 520, or lenses if there are more than one (refer also to FIGS. 1-7). In an embodiment, hood 22 is fabricated from a flexible material so that it can be wrapped around top section 516 of handheld smart device 500 (refer also to FIGS. 13-18). In various embodiments hood 22 can be fabricated from fabric (woven or non-woven), leather, a planar sheet of rubber or other friction-enhancing material, paper, or any other material which will wrap around top section 516 of handheld smart device 500 and protect lens 520 from contaminants, shield lenses 520 from mechanical damage, and block the passage of visual images. In the shown embodiment, hood 22 is rectangular having four corners 24. Hood 22 has four apertures 26, one aperture 26 disposed at each of the four corners 24. In the shown embodiment, apertures 26 are formed by grommets 28.

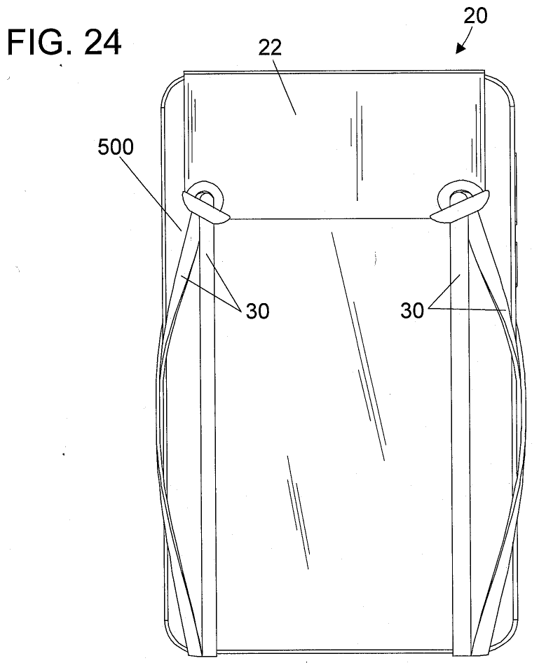

Hood 22 has a width WH and a length LH. In an embodiment, hood 22 has (1) a small size to fit small smart phones, (2) a medium size to fit large smartphones, and (3) a large size to fit a standard size tablet computer (refer to FIG. 24). In various embodiments, the width WH and length LH of the above-cited three sizes are:
a) SMALL:
   WIDTH: 2.5 inches-3.5 inches
   LENGTH: 4 inches-4.5 inches
b) MEDIUM:
   WIDTH: 3.5 inches-4.5 inches
   LENGTH: 4.5 inches-5.5 inches
c) LARGE:
   WIDTH: 4.5 inches-5.5 inches
   LENGTH: 5.5-6.5 inches

However it may be appreciated that the size of hood 22 can vary to accommodate any size handheld smart devices 500.

Four elastic bands 30 are connectable to hood 22. In FIGS. 8-12 elastic bands are connected to hood 22, and in FIG. 19 elastic bands 30 are separate and not connected to hood 22. That is, elastic bands 30 and hood 22 of flexible material are formed of separate structures. One elastic band 30 is connectable (removably connectable in the shown embodiment) to each of the four corners 24. One elastic band 30 interfaces with each of apertures 26. Elastic bands 30 are configured to pass through apertures 26 and loop back though themselves, thereby “tying” the elastic bands 30 to hood 22. In an embodiment, elastic bands 30 are flexible, durable, and breakage resistant, and can withstand repeated stretching and contracting cycles. Additionally bands 30 are resistant to abrasion or other damage which could result from placing handheld smart device 500 with lens protector installed in a phone case.

In an embodiment, elastic bands 30 are fabricated from a friction-enhancing material such as rubber so that they will better grip and stay in place when wrapped around handheld smart device 500 (refer to FIGS. 13-18 and the associated discussions). However other elastomers could also be utilized. Also, in an embodiment elastic bands 30 have a thickness t of less than one sixteenth of an inch (refer to FIG. 20). The four elastic bands 30 are configured to stretch and wrap around the bottom edge 510 of handheld smart device 500, and hold hood 22 in place around top section 516 of smart device 500 (refer to FIGS. 13-18 and the associated discussions). It is noted that the elastic bands 30 shown in the figures are representative. It may be appreciated that elastic bands 30 of other shapes, sizes, and cross sections could also be utilized. For example a “bungee cord” could be utilized.

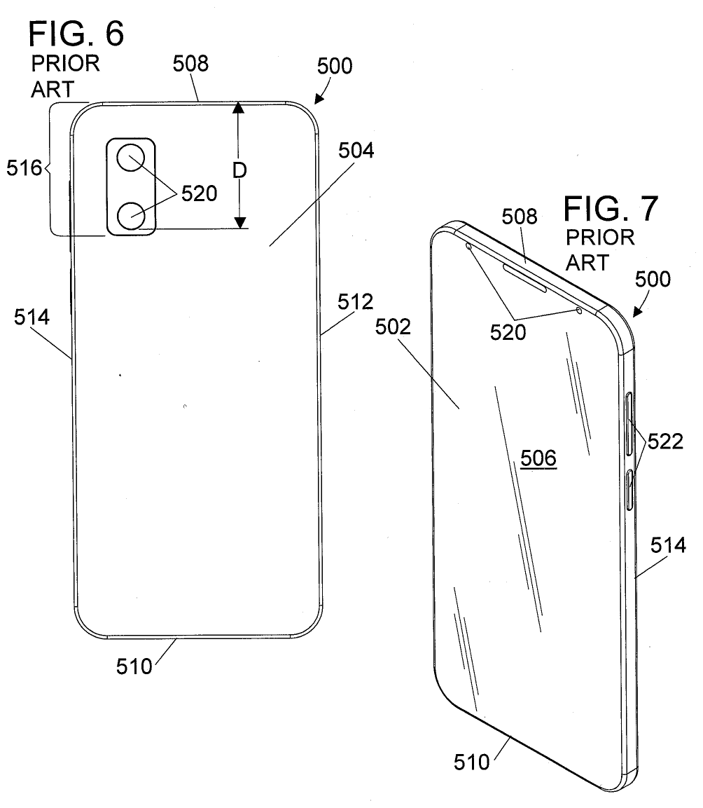

FIGS. 13-18 are top, front, bottom, side elevation, opposite side elevation, and rear views respectively of the handheld smart device 500 with lens protector 20 installed. thereon. Hood 22 has been placed over top section 516 of handheld smart device 500 so that it covers and protects all camera lenses 120, both on front side 502 and rear side 504 of handheld smart device 500 (refer also to FIGS. 2 and 6). Elastic bands 30 are then stretched and wrapped around bottom edge 510 of handheld smart device 500. Elastic bands 30 then contract and grip front side 502, rear side 504, and bottom edge 510 and hold hood 22 in place around top section 516 of handheld smart device 500. The wrapping of elastic bands 30 is effected such that two elastic bands 30 are disposed adjacent to left edge 512 of handheld smart device 500, and two other elastic bands 30 are disposed adjacent to right edge 514 of handheld smart device 500. This wrapping process leaves much of display 506 visible. In an embodiment the thickness of elastic bands 30 is less than on sixteenth of an inch, so that handheld smart device 500 with lens protector 20 installed will fit into a carrying case.

It is an inherent feature of the wrapping process that an elastic band 30 cross over bottom edge 510 and a side edge (left side edge 512 or right side edge 514) of handheld smart device 500. For illustration purposes in FIGS. 14, 15, 16, and 18 the path A of one elastic band 30 has been shown. In an embodiment, elastic bands 30 are fabricated from a friction-enhancing material (such as rubber). As such, when wrapped around handheld smart device 500 the bands tend to stay in place on the surface of handheld smart device 500. As such, elastic bands 30 can be positioned so as not to engage controls 522 disposed on the side edges (left side edge 512, or right side edge 514) of handheld smart device 500.

Hood 22 must have a length LH (refer to FIG. 8) which is sufficient to cover lenses 120 on both the front 502 and rear 504 of handheld smart device 500. This means that hood 22 must extend downward from the top edge 508 of handheld smart device 500 a distance which is at least (equal to or greater than) as long as the distance D from the top edge 508 to the lowermost point of the camera lens 120. In the shown embodiment the lowermost point of all the camera lenses 120 is on rear side 504 (refer to FIG. 6). Since hood 22 extends down equally on both sides of handheld smart device 500, the length LH of hood 22 can be defined as:

LH≥2D+T where,
LH is the length of hood 22,
D is a distance from the top edge 508 to the lowermost point on the camera lens 120, and,
T is the thickness of the handheld smart device 500 (refer to FIG. 1).

FIG. 19 is a perspective view of lens protector 20 with elastic bands 30 disconnected from hood 22. Lens protector 20 can have elastic bands 30 separate from hood 22, wherein the user connects the elastic bands 30 to hood 22. Alternatively, lens protector 20 can have elastic bands 30 connected to hood 22 as is shown in FIGS. 8-12. Also shown are apertures 26 of hood 22.

FIG. 20 is a cross sectional view along the line 20-20 of FIG. 19 showing the cross sectional shape of an elastic band 30. In this embodiment elastic band 30 has a rectangular cross section with a thickness of t.

FIG. 21 is a plan view of another embodiment elastic band 30, and FIG. 22 is a cross sectional view along the line 22-22 of FIG. 21. In this embodiment each elastic band 30 has a rectangular cross section with a ridge (raised portion 31) disposed on one side. This embodiment provides additional strength and durability when handheld smart device 500 with lens protector 20 installed is put in a carrying case.

FIG. 23 is a plan view of a second embodiment lens protector 20. In this embodiment hood 22 and elastic bands 30 are formed from a common sheet of flexible elastic material (such as a sheet of rubber).

FIG. 24 is a front view of lens protector 20 installed on and covering the lenses of a different handheld smart device 500, a tablet computer. Hood 22 and elastic bands 30 are wrapped around tablet computer 500 as in FIGS. 13-18.

It may be appreciated that lens protector 20 and handheld smart device 500 may be combined to form a lens-protecting system.

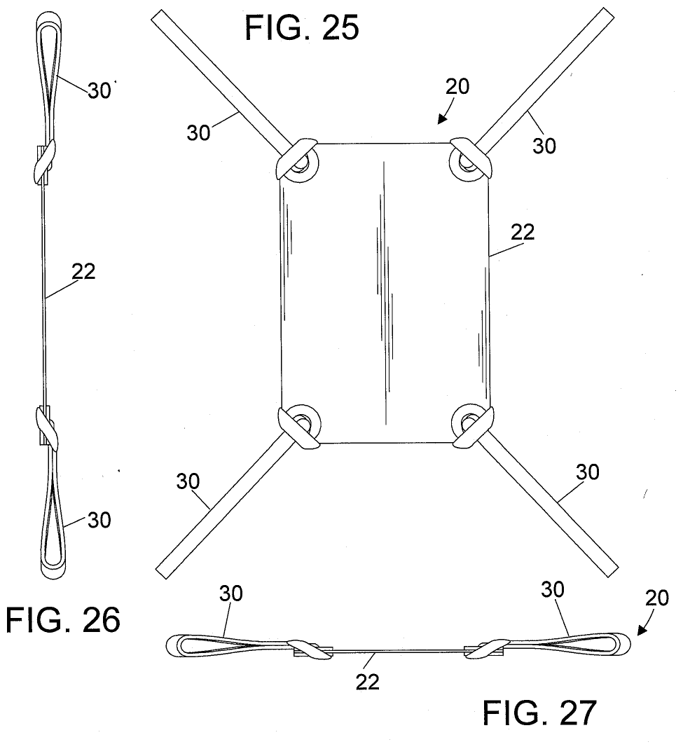

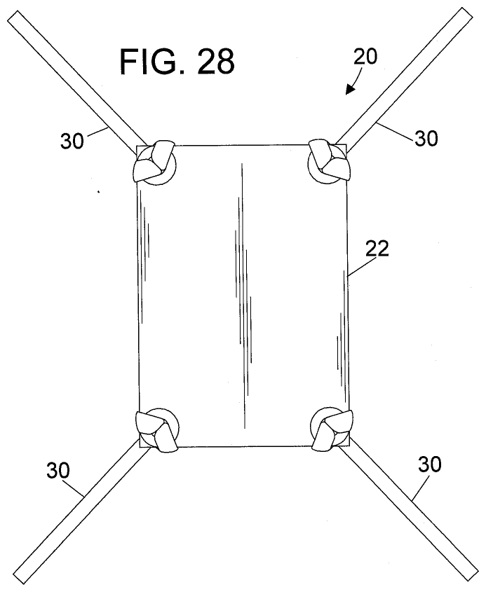

FIGS. 25-28 are front plan, side elevation, other side elevation, and rear plan views respectively of lens protector 20. In these views elastic bands 30 have a different tying configuration. That is, they emanate from grommets 28 in a different manner.

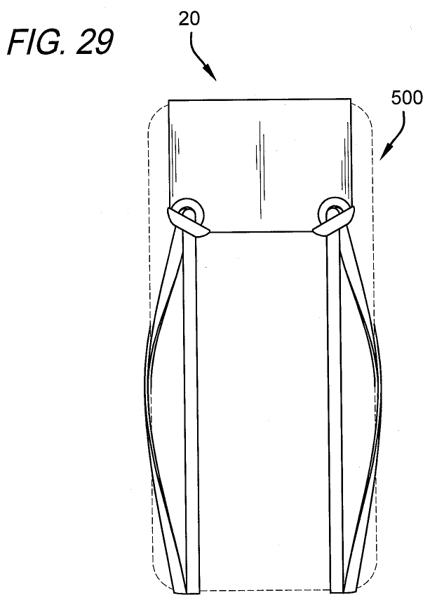

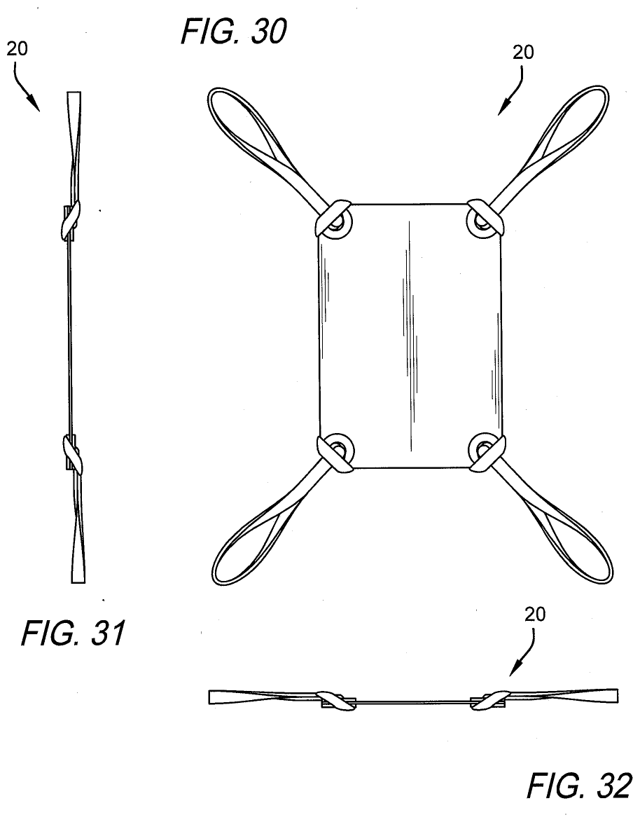

FIG. 29 shows an additional view of lens protector 20 and handheld smart device 500.

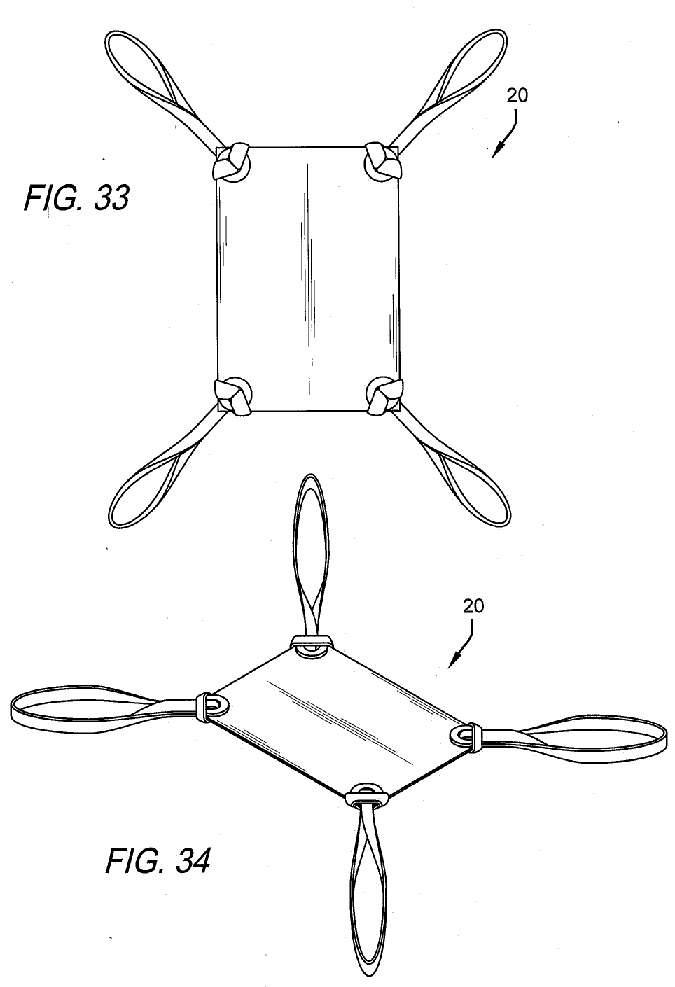

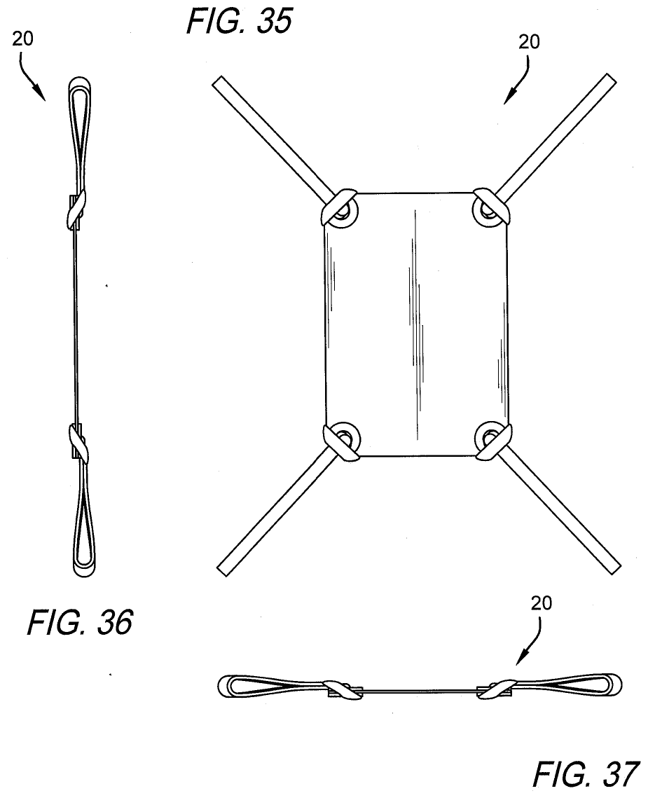

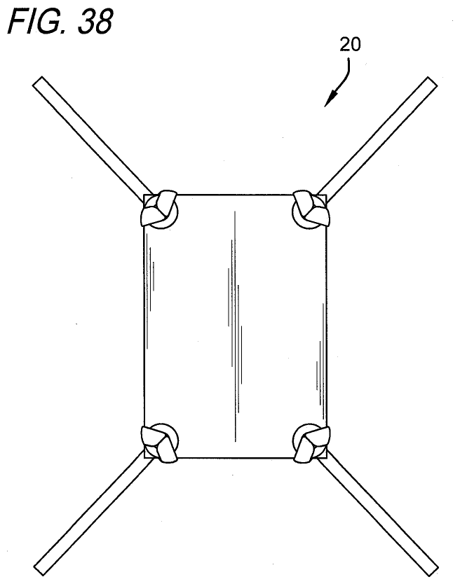

FIGS. 30-38 show additional views of lens protector 20.

In terms of use, a lens-protecting method includes (refer to FIGS. 1-38):
(a) providing a handheld smart device 500 having a top section 516, a bottom edge 510, and a camera lens 520 disposed at the top section 516;
(b) providing a lens protector 20 for the handheld smart device 500 including:
   a hood 22;
   four elastic bands 30 connected to the hood 22;
(c) wrapping the hood 22 around the top section 516 of the handheld smart device 500 covering the camera lens 520; and,
(d) wrapping the four elastic bands 30 around the bottom edge 510 of the handheld smart device 500.

The lens-protecting method further including:
in (b), the hood 22 being rectangular having four corners 24; and,
one elastic band 30 connected to each of the four corners 24.

The lens-protecting method further including:
in (b), the hood 22 being fabricated from a friction-enhancing material.

The lens-protecting method further including:
in (a) the handheld smart device 500 having a side edge 512 or 514 with controls 522 disposed thereon;
in (b), the elastic bands 30 being fabricated from a friction-enhancing material; and,
positioning the elastic bands 30 so as not to engage the controls 522.

The lens-protecting method further including:
in (a), the handheld smart device having a left edge 512 and a right edge 514;
in (d) positioning two of the elastic bands 30 adjacent to the left edge 512 of the handheld smart device 500; and,
in (d), positioning two of the elastic bands 30 adjacent to the right edge 514 of the handheld smart device 500.

The lens-protecting method further including:
in (b), the hood 22 being rectangular having four corners 24;
one the elastic band 30 connected to each of the four corners; 24
the hood 22 having four apertures 26, one aperture disposed at each of the four corners 24; and,
passing the elastic bands 30 through the apertures 26 and looping them back though themselves.

The embodiments of the lens protector for a handheld smart device and method of use described herein are exemplary and numerous modifications, combinations, variations, and rearrangements can be readily envisioned to achieve an equivalent result, all of which are intended to be embraced within the scope of the appended claims. Further, nothing in the above-provided discussions of the lens protector for a handheld smart device and method should be construed as limiting the invention to a particular embodiment or combination of embodiments. The scope of the invention is defined by the appended claims.

I claim:

1. A lens protector for a handheld smart device, the handheld smart device having a top section, a bottom edge, a camera lens disposed at said top section, the lens protector comprising:
a hood fabricated from a flexible material, said hood configured to wrap around the top section of the handheld smart device and cover the camera lens;
four elastic bands connectable to said hood; and,
said four elastic bands configured to wrap around the bottom edge of the handheld smart device.

2. The lens protector for a handheld smart device according to claim 1, further including:
said hood being rectangular having four corners; and,
one said elastic band connectable to each of said four corners.

3. The lens protector for a handheld smart device according to claim 2, further including;
said hood having four apertures, one aperture disposed at each of said four corners.

4. The lens protector for a handheld smart device according to claim 3, further including;
said four apertures formed by four grommets.

5. The lens protector for a handheld smart device according to claim 1, further including;
said four elastic bands being removably connectable to said hood.

6. The lens protector for a handheld smart device according to claim 5, further including;
said hood being rectangular having four corners;
one said elastic band connectable to each of said four corners;
said hood having four apertures, one aperture disposed at each of said four corners; and,
said elastic bands configured to pass through said apertures and loop back though themselves.

7. The lens protector for a handheld smart device according to claim 1, further including:
said hood being fabricated from a friction-enhancing material.

8. The lens protector for a handheld smart device according to claim 1, further including:
said elastic bands being fabricated from a friction-enhancing material.

9. The lens protector for a handheld smart device according to claim 1, further including:
said elastic bands having a thickness of less than one sixteenth of an inch.

10. The lens protector for a handheld smart device according to claim 1, the handheld smart device having a left edge and a right edge, the lens protector further including:
two of said elastic bands disposable adjacent to the left edge of the handheld smart device; and,
two of said elastic bands disposable adjacent to the right edge of the handheld smart device.

11. A lens protector for at least one camera of a handheld smart device, the lens protector comprising in combination:
a hood of flexible material having four corners; and
four elastic bands coupled to said hood of flexible material, said elastic bands located adjacent to said four corners of said hood of flexible material.

12. The lens protector of claim 11 wherein said hood of flexible material and said elastic bands are formed from a common sheet of flexible elastic material.

13. The lens protector of claim 11 wherein said elastic bands and said hood of flexible material are formed of separate structures, and with said hood of flexible material including at least four apertures adjacent to said four corners of said hood of flexible material, and with one of said elastic bands interfacing with each of said apertures.

14. The lens protector of claim 13 wherein said elastic bands are tied in position passing through said apertures.

15. The lens protector of claim 13 wherein said apertures are formed by four grommets.

16. The lens protector of claim 11 wherein said hood of flexible material has a rectangular form.

17. The lens protector of claim 16 wherein said hood of flexible material is between 2.5 and 3.5 inches wide, and between 4 and 4.5 inches long.

18. The lens protector of claim 16 wherein said hood of flexible material is between 3.5 and 4.5 inches wide, and between 4.5 and 5.5 inches long.

19. The lens protector of claim 16 wherein said hood of flexible material is between 4.5 and 5.5 inches wide, and between 5.5 and 6.5 inches long.

20. The lens protector of claim 11 wherein said hood of flexible material is formed of leather.

21. The lens protector of claim 11 wherein said hood of flexible material is formed of fabric.

22. The lens protector of claim 11 wherein said hood of flexible material is formed of a planar sheet of rubber.

23. A lens-protecting system, comprising:
a handheld smart device having a top section, a bottom edge, and a camera lens disposed at said top section;
a lens protector for said handheld smart device including:
a hood fabricated from a flexible material;
four elastic bands connected to said hood;
said hood wrapped around said top section of said handheld device and covering said camera lens; and,
said four elastic bands wrapped around said bottom edge of said handheld smart device.

24. The lens-protecting system according to claim 23 further including:
said hood being rectangular having four corners; and,
one said elastic band connected to each of said four corners.

25. The lens-protecting system according to claim 23 further including;
said hood having four apertures, one aperture disposed at each of said four corners.

26. The lens-protecting system according to claim 25, further including;
said four apertures formed by four grommets.

27. The lens-protecting system according to claim 23, further including;
said four elastic bands being removably connected to said hood.

28. The lens-protecting system according to claim 27, further including;
said hood being rectangular having four corners;
one said elastic band connected to each of said four corners;
said hood having four apertures, one aperture disposed at each of said four corners; and,
said elastic bands passing through said apertures and looping back though themselves.

29. The lens-protecting system according to claim 23 further including:
said hood being fabricated from a friction-enhancing material.

30. The lens-protecting system according to claim 23, further including:
said elastic bands being fabricated from a friction-enhancing material.

31. The lens-protecting system according to claim 23, further including:
said elastic bands having a thickness of less than one sixteenth of an inch.

32. The lens-protecting system according to claim 23 further including:
said handheld smart device having a distance D from said top edge to a lowermost point on said camera lens;
said hood being rectangular having four corners;
said hood having a length L defined as;
LH≥2D+T where;
LH is the length of said hood,
D is a distance from the top edge to the lowermost point on the camera lens, and
T is the thickness of the handheld smart device.

33. The lens-protecting system according to claim 23,
said handheld smart device having a left edge and a right edge;
two of said elastic bands disposed adjacent to said left edge of said handheld smart device; and,
two of said elastic bands disposed adjacent to said right edge of said handheld smart device.

34. A lens-protecting method, comprising:
(a) providing a handheld smart device having a top section, a bottom edge, and a camera lens disposed at said top section;
(b) providing a lens protector for said handheld smart device including:
a hood;
four elastic bands connected to said hood;
(c) wrapping said hood around said top section of said handheld smart device covering said camera lens; and,
(d) wrapping said four elastic bands around said bottom edge of said handheld smart device.

35. The lens-protecting method according to claim 34 further including:
in (b), said hood being rectangular having four corners; and,
one said elastic band connected to each of said four corners.

36. The lens-protecting method according to claim 34, further including:
in (b), said hood being fabricated from a friction-enhancing material.

37. The lens-protecting method according to claim 34 further including:
in (a) said handheld smart device having a side edge with controls disposed thereon;
in (b), said elastic bands being fabricated from a friction-enhancing material; and,
positioning said elastic bands so as not to engage said controls.

38. The lens-protecting method according to claim 34,
in (a), said handheld smart device having a left edge and a right edge;
in (d) positioning two of said elastic bands adjacent to said left edge of said handheld smart device; and,
in (d), positioning two of said elastic bands adjacent to said right edge of said handheld smart device.

39. The lens-protecting method according to claim 34, further including:
in (b), said hood being rectangular having four corners;
one said elastic band connected to each of said four corners;
said hood having four apertures, one aperture disposed at each of said four corners; and,
passing said elastic bands through said apertures and looping them back though themselves.
